(19) United States
(12) Patent Application Publication
(10) Pub. No.: US 2026/0275252 A1
(43) Pub. Date: Sep. 17, 2026

(54) LAUNDRY DETERGENT ARTICLE

(71) Applicant: Church & Dwight Co., Inc., Princeton, NJ (US)

(72) Inventors: Jae Won KIM, Princeton, NJ (US); Christine BOYKE, Somerset, NJ (US); Irina GANOPOLSKY, Flemington, NJ (US)

(73) Assignee: Church & Dwight Co., Inc., Princeton, NJ (US)

(21) Appl. No.: 19/566,156

(22) Filed: Mar. 13, 2026

Related U.S. Application Data
(60) Provisional application No. 63/772,023, filed on Mar. 14, 2025.

(51) Int. Cl. C11D 17/04; C11D 1/722; C11D 1/83; C11D 3/22; C11D 3/37; C11D 17/06

(52) U.S. Cl. CPC C11D 17/044; C11D 1/722; C11D 1/83; C11D 3/222; C11D 3/3753; C11D 17/06

(57) ABSTRACT

The present disclosure provides cleaning articles. The articles can be formed of a detergent composition and a film former, and a foam stabilizer. The detergent composition can comprise at least one surfactant. The cleaning article can be configured as a substantially solid foam structure that is soluble in aqueous liquid and substantially non-flowing at a temperature of about 80° C. or less when out of contact with the aqueous liquid. The surfactant can include a relatively high concentration of non-ionic surfactants that do not lessen the integrity of the cleaning article. The surfactants can particularly comprise C₁₆ or greater non-ionic surfactants, such as C₁₆ or greater alcohol ethoxylates.

### CROSS-REFERENCE TO RELATED APPLICATIONS

The present application claims priority to U.S. Provisional Patent Application No. 63/772,023, filed on Mar. 14, 2025, the entire contents of which are incorporated herein by reference.

### FIELD OF THE DISCLOSURE

The present disclosure relates to laundry detergent articles prepared with detergent formulations that provide improved cleaning efficacy.

### BACKGROUND

The use of water-soluble film carriers to deliver unit dosage amounts of laundry products is known, and detergents and bleaches have been sold in this form for many years. Known unit dose detergent articles can be limited in their ability to provide high-efficacy detergent formulations. A favored aspect of unit dosage articles is ease of handling without fear of prolonged exposure of the skin to strong detergent components. Laundry sheets offer ease of handling, but the presence of the detergent components held directly in or on the laundry sheets increases opportunity for prolonged skin contact. As such, less harsh, and less effective detergent materials may be used in such laundry articles. Similarly, many high performance detergent materials, such as strong surfactants, can impart a “greasy” or “slimy” feel that is undesirable for handling with bare hands.

There is still a desire and a need to provide laundry detergent compositions that are in unit dose forms. There is also a desire and need for unit dose laundry compositions and articles that exhibit high cleaning efficacy while maintaining a consumer expected experience for comfortable handling of the unit dose articles.

### SUMMARY OF THE DISCLOSURE

The present disclosure provides laundry detergent articles. A laundry detergent article as described herein can be provided as a unit dose article in that the article is intended to provide, as an individual unit, a sufficient quantity of detergent for carrying out laundering of a typical load in standard washing machines. The articles comprise a detergent and are in the form of a water soluble sheet material configured to provide the unit dose. More particularly, a unit dose laundry detergent article according to the present disclosure can be defined by a single sheet, formed of a single layer of material. An individual sheet can be specifically configured as a substantially solid foam that comprises a water soluble material. The sheet can include pores that provide for improved storage of detergent components and infiltration of water for dissolution and delivery of the detergent in a washing medium. The configuration of the disclosed laundry detergent article can provide multiple advantages, such as improving diffusion of the detergent, increasing stability during storage, and beneficially providing additive cleaning efficacy.

In one or more embodiments, the present disclosure may provide cleaning articles. For example, a cleaning article according to the disclosure may comprise: a detergent composition comprising at least one non-ionic surfactant with at least one associated hydrocarbon chain having a carbon chain length of greater than 15 carbon atoms; and a film former comprising a water-soluble polymer; wherein the cleaning article is configured as a substantially solid foam structure that is soluble in an aqueous liquid and is substantially non-flowing at a temperature of about 80° C. or less when out of contact with the aqueous liquid. The cleaning article may be further defined in relation to any one or more of the following statements, which may be combined in any number or order.

The at least one non-ionic surfactant may have at least one associated hydrocarbon chain having a carbon chain length of 16 to 20 carbon atoms.

The at least one non-ionic surfactant may have at least one associated hydrocarbon chain having a carbon chain length of 16 to 18 carbon atoms.

The at least one non-ionic surfactant may be an ethoxylated alcohol.

The at least one non-ionic surfactant may be a C₁₆-C₂₀ ethoxylated alcohol.

The at least one non-ionic surfactant may be a C₁₆-C₁₈ ethoxylated alcohol.

The cleaning article may comprise about 2% by weight or greater of the at least one non-ionic surfactant, based on the total weight of the cleaning article.

The cleaning article may comprise about 5% by weight or greater of the at least one non-ionic surfactant, based on the total weight of the cleaning article.

The cleaning article may comprise about 10% by weight or greater of the at least one non-ionic surfactant, based on the total weight of the cleaning article.

The detergent composition further may comprise one or more anionic surfactants.

The water-soluble polymer may be a polyvinyl alcohol.

The water-soluble polymer may be a polysaccharide.

The water-soluble polymer may comprise hydroxypropyl methylcellulose (HPMC), methyl cellulose low-viscosity (MCLV), xanthan gum, pullulan, or combinations thereof.

The detergent composition further may comprise one or more materials selected from the group consisting of enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).

The cleaning article may be configured as a sheet having a thickness, and a length and a width that are each greater than the thickness.

### DETAILED DESCRIPTION OF THE DISCLOSURE

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure provides cleaning articles, such as, for example, laundry detergents. The cleaning articles can be provided as substantially solid articles so that they are capable of being handled directly by a consumer and substantially retain their shape throughout such handling. A cleaning article according to the present disclosure can be defined as a single object that can be a single mass of a substantially uniform composition. “Uniform” as used herein indicates that the components are evenly mixed so as to be substantially homogenously distributed. In certain embodiments, a cleaning article of the present disclosure can be shaped so as to be substantially sheet-like and thus may be defined by a single layer which is shaped like a sheet.

The structural arrangement of the disclosed cleaning articles can increase efficiency of the cleaning article as, for example, a laundry detergent. For example, the high surface area of the cleaning article, when arranged in a sheet form, can increase the rate of dissolution of the cleaning article. The dissolution rate of the cleaning article directly affects the efficiency and performance of the cleaning article. For example, providing for a faster release of the components of the cleaning article into the washing liquid can increase the likelihood that substantially the entirety of the cleaning article components are dispersed during the wash cycle to provide their individual cleaning functions. Furthermore, a faster dissolution rate can be more environmentally friendly due to a shortened wash cycle, resulting in less water and power usage during laundering.

The cleaning articles described herein can be provided in a variety of shapes and sizes. For example, the overall cleaning article when viewed from the top or bottom, can be substantially in the form of a square, rectangle, parallelogram, triangle, circle, or other shape, but conveniently may have a rectangular or square shape when viewed normally to the plane of its two longest dimensions. A rectangular or square cleaning article may be more easily manufactured than other configurations when using conventional packaging equipment.

The disclosed cleaning articles can be provided in different sizes and weights (e.g., small, medium, large) to accommodate different consumer needs. The sizes can correspond to a recommended detergent dose for laundry fabric loads or levels of soil. The weight and dimensions of the cleaning articles can be balanced to ensure quick and complete dissolution of the article in the wash water for rapid delivery of the detergent composition into the water. In various embodiments, the cleaning articles described herein can have a length defined by an upper length of about 30 cm and a lower length of about 5 cm, the length including all possible ranges bounded by the upper length and the lower length (e.g., about 5 cm to about 30 cm, about 10 cm to about 25 cm, etc.) and, as such, every whole number from about 5 to about 30 (or fractions thereof) is expressly included in this disclosure for defining upper and lower boundaries of the encompassed ranges. Likewise, the length can be “at least” any of the values within the above range or can be “less than” any of the values within the above range.

In various embodiments, the cleaning articles can have a width defined by an upper width of about 20 cm and a lower width of about 3 cm, the width including all possible ranges bound by the upper width and the lower width (e.g., 3 about cm to about 20 cm, about 5 cm to about 15 cm, etc.). Likewise, the width can be “at least” any of the values within the above range or can be “less than” any of the values within the above range. In some embodiments, the cleaning article can have a ratio of length to width (i.e., L:W) of about 1:1 to about 10:1, about 1:1 to about 5:1, or about 1:to about 3:1.

In various embodiments, the cleaning articles can have a thickness defined by an upper thickness of about 20 mm and a lower thickness of about 1.5 mm, the thickness including all possible ranges bound by the upper thickness and the lower thickness (e.g., about 1.5 mm to about 20 mm, about 2 mm to about 15 mm, etc.) and, as such every whole number between about 1.5 and about 20 (or fractions thereof) is expressly included in this disclosure for defining upper and lower boundaries of the encompassed ranges. Likewise, the thickness can be “at least” any of the values within the above range or can be “less than” any of the values within the above range. In some embodiments, the cleaning article can be configured to have a length and a width that are each greater than the thickness. For example, the cleaning article can have a ratio of length to thickness (L:T) of about 10:1 to about 200:1, about 15:1 to about 100:1, or about 20:1 to about 80:1. Ratios of width to thickness (W:T) can be within the same ranges as the L:T ratios with the W:T ratio being equal to or less than the L:T ratio.

The structural arrangement of the disclosed cleaning articles can increase efficiency of the cleaning article as, for example, a laundry detergent. For example, the high surface area of the cleaning article, when arranged in a sheet form, can increase the rate of dissolution of the cleaning article. The dissolution rate of the cleaning article directly affects the efficiency and performance of the cleaning article. For example, providing for a faster release of the components of the cleaning article into the washing liquid can increase the likelihood that substantially the entirety of the cleaning article components are dispersed during the wash cycle to provide their individual cleaning functions. Furthermore, a faster dissolution rate can be more environmentally friendly due to a shortened wash cycle, resulting in less water and power usage during laundering. The size and shape of the sheet may also be beneficial for improving loading of detergent components across a greater surface area so there are less concentrated amounts of detergent at any one position on the sheet for potential transfer to the hands of a user.

As such, a cleaning article according to the present disclosure can be configured as a substantially solid foam. A solid foam may be rigid. A solid foam may be flexible. A solid foam may be compressible. In any state, a solid foam is a foam that does not dissipate or reduce to a non-foamed state after achieving the solid state. A solid foam structure useful as a cleaning article can comprise a detergent composition and a water soluble film former or carrier, which are mixed and processed to achieve a flowable foam. Such processing can comprise aeration of a non-foamed, viscous liquid, gel, slurry, or paste to incorporate air. Processing can further comprise drying the composition so that the incorporated or entrained air forms pores, as noted herein. Accordingly, the phrase “solid foam” indicates a structure that is characterized by the presence of pores, which can be discrete pores or interconnecting pores, achieved by the specific incorporation of a gas (e.g., air) into the composition when in a liquid or flowable form so that the pores remain upon solidification of the composition into a solid or non-flowable form

A solid foam structure useful as a cleaning article disclosed herein will be substantially or completely non-flowing at a temperature of about 80° C. or less and at ambient pressure when out of contact with an aqueous liquid. In some embodiments, the foam structure will be substantially or completely non-flowing at a temperature of about 70° C. or less, about 60° C. or less, or about 50° C. or less at ambient pressure when out of contact with an aqueous liquid. Completely non-flowing is understood to mean at least about 99.9% by weight of the cleaning article retains a solid shape, and substantially non-flowing is understood to mean at least about 97.5%, at least about 98%, at least about 98.5%, at least about 99%, or at least about 99.5% by weight of the cleaning article retains a solid shape.

The solid foam structure likewise will exhibit a solubility in water as otherwise described herein. In some embodiments, the foam structure will be substantially or completely water soluble, such as, for example, at a temperature of about 30° C. or less in a time of about 10 minutes or less. In other examples the foam structure can be substantially or completely water soluble at a temperature of about 20° C. or less, about 15° C. or less, or in a range of about 10° C. to about 30° C., in a time of about 10 minutes or less, about 7 minutes or less, about 5 minutes or less, or in a range of about 2 minutes to about 10 minutes. Completely water soluble is understood to mean at least 99.9% by weight of the film former is solubilized in the water, and substantially water soluble is understood to mean at least 98%, at least 98.5%, at least 99%, or at least 99.5% of the film former is solubilized in the water.

Dissolution time of the disclosed cleaning articles is directly affected by the permeability, porosity (and corresponding degree of aeration), thickness, and/or other parameters of the solid foam structure. In various embodiments, the solid foam structure described herein can have a permeability which ensures that liquid from the wash water permeates the cleaning article and provides a desirable rate of dissolution. In various embodiments, the solid foam structure can have pore sizes configured to achieve the desired permeability. Porosity can be determined qualitatively by a visual examination of the pore size of the solid foam structure. In some embodiments, the porosity can be defined in relation to the average size of pores within the solid foam structure. More commonly, however, porosity is instead measured by sheet density (mass per volume), which also offers higher accuracy. In the disclosed cleaning articles, porosity can be defined as the fraction of void space in the material, where the void contains air. Specifically, porosity can be determined by dividing the volume of the voids within the solid foam structure by the total volume of the solid foam structure. In one or more embodiments, the porosity (mass per volume) can range from about 0.2 g/cm³ to about 0.4 g/cm³.

Cleaning articles configured as a substantially solid foam structure, or detergent compositions included in such cleaning articles, can comprise a wide variety of components or materials that are useful in the laundering of fabrics and, more specifically, clothing items. The cleaning articles can be characterized as comprising one or more cleaning components with it being understood that the phrase “cleaning component” indicates that it is a component useful in a laundry detergent composition. The one or more cleaning components can be selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s),disintegrant(s), such as sodium starch glycolate, and laundry booster(s). Particularly, the cleaning articles can comprise a plurality of components and preferably in a substantially concentrated form. As used herein, “concentrated” indicates that the detergent composition is not diluted, or is only minimally diluted, by non-detergent materials, such as water. A concentrated detergent composition specifically will comprise less than 10%, less than 5%, less than 2%, or less than 1% by weight of non-detergent materials. A non-detergent material is any material that is not typically included in detergent compositions for the purpose of providing a cleaning or detergency purpose. As non-limiting examples, a concentrated detergent composition or cleaning composition can be a composition wherein at least 90%, at least 95%, at least 98%, or at least 99% by weight of the composition is only components selected from the previously provided list in any number. Any one or more of such components may be presently individually in the cleaning article or may be included in a detergent composition that itself is included in the cleaning article. Individual cleaning components or detergent compositions may be coated on the cleaning article, may be absorbed or adsorbed by the cleaning article, or may be intermixed with one or more further materials of the cleaning article, such as being intermixed with a film-former, so as to be substantially evenly distributed throughout the cleaning article.

In one or more embodiments, the cleaning article may include at least one non-ionic surfactant. Non-ionic surfactants may be particularly effective for removing lipids, fats, oils and other greasy stains from fabrics. Accordingly, it may be desirable to include non-ionic surfactants in a detergent composition in a relatively high concentration to provide a product with high grease removing efficacy. The chemical nature of many non-ionic surfactants, however, may expressly limit the loading capacity of non-ionic surfactants in cleaning articles. In particular, a cleaning article that is configured as a substantially solid foam may be adversely affected by high loading of non-ionic surfactants, particularly articles configured in a relatively thin format, such as a sheet format. High concentrations of non-ionic surfactants may cause solid cleaning articles to exhibit a greasy or sticky sensation when touched. This causes multiple disadvantages. Consumers may not wish to use cleaning articles that leave hands feeling greasy or sticky after handling. Being overly greasy or sticky can also cause the cleaning articles to adhere together making them difficult to separate from one another and use in the proper dosage for laundry wash loads. Greasy residue may also transfer from the cleaning article to surrounding packing during shipping, storage, and consumer handling, and this may lead to loss of integrity by the packaging material. Likewise, greasy residue may cause the solid laundry article to lose integrity, such as tearing into pieces during handling or weeping of the solid laundry article.

Surprisingly, it has been found that non-ionic surfactants may still be incorporated into solid cleaning articles, such as laundry sheets, in relatively high concentrations to provide high cleaning efficacy without suffering from the disadvantages discussed above. In particular, this can be achieved through selection of non-ionic surfactants that include relatively long carbon chains. Many non-ionic surfactants comprise compounds that include one or more hydrocarbon chains of varying lengths based upon the number of carbon atoms present. Carbon chain length may be described by the letter “C” followed by a number indicating the number of consecutive carbon atoms forming the hydrocarbon chain. In one or more embodiments, a cleaning article or a detergent composition according to the present disclosure may comprise a single non-ionic surfactant, at least one non-ionic surfactant, one or more non-ionic surfactants, two or more non-ionic surfactants, or a plurality of non-ionic surfactants that have a carbon chain length within a specific range so that the cleaning article or detergent composition exhibits good cleaning efficacy with reduced or no instance of the disadvantages described above. The non-ionic surfactant(s) specifically may comprise a hydrocarbon chain having a carbon chain length of greater than 15 carbon atoms (“C₁₅₊ₙ”, where “n” is an integer from 1 to 10). The non-ionic surfactant(s) may comprise a hydrocarbon chain having a carbon chain length of 16 to 25 carbon atoms (“C₁₆-C₂₆”), 16 to 20 carbon atoms (“C₁₆-C₂₀”), or 16 to 18 carbon atoms (“C₁₆-C₁₈”). Such carbon chain lengths may, in one or more embodiments, particularly apply to the aliphatic alcohol chain remaining in an alcohol ethoxylate non-ionic surfactant.

In one or more embodiments, a cleaning article or detergent composition according to the present disclosure may comprise one or more non-ionic surfactants including a hydrocarbon having a carbon chain length of less than 16 carbon atoms (“C₁₅ or lesser carbon chain length”), such as 6 to 15 carbon atoms (“C₆-C₁₅”), 7 to 14 carbon atoms (“C₇-C₁₄”), or 8 to 12 carbon atoms (“C₈-C₁₂”). In one or more embodiments, a cleaning article or detergent composition may expressly exclude non-ionic surfactants that include a hydrocarbon having a carbon chain length of C₁₅ or less, C₁₄ or less, C₁₃ or less, or C₁₂ or less. As such, any non-ionic surfactants present in a cleaning article or detergent composition according to the present disclosure may consist of non-ionic surfactants comprising a hydrocarbon chain length of C₁₅₊ₙ, where n is an integer from 1 to 10, or a carbon chain length of C₁₆ or greater, such as within any of said ranges described above.

In one or more embodiments, non-ionic surfactants for use in the present cleaning articles or detergent compositions can be selected from, for example, the group of alcohol ethoxylates or ethoxylated alcohols. The group of alcohol ethoxylates can encompass non-ionic surfactants that are alkyl ethoxylate condensation products of aliphatic alcohols derived through the process of reacting an aliphatic alcohol with ethylene oxide. The non-ionic surfactant may be defined in relation to the length of the aliphatic hydrocarbon chain from the alcohol or the number of ethoxylate groups present in the molecule. In one or more embodiments, the carbon chain lengths described above may specifically define the number of carbon atoms in the aliphatic alcohol hydrocarbon chain. The alkyl chain of the aliphatic alcohol can either be straight or branched, primary or secondary, and preferably contains from 16 to 26 carbon atoms, such as 16 to 20 carbon atoms, or such as 16 to 18 carbon atoms. Suitable alcohol ethoxylate non-ionic surfactants may comprise any number of moles of ethylene oxide per mole of alcohol, such as having a degree of ethoxylation of up to 30. Non-limiting examples of non-ionic surfactants that may be used herein include ethoxylated alcohols (AE) (C₁₆₋₁₈ alcohols, in particular), such as Lutensol® AT 25 pellets (available from BASF), Ecosurf™ Bright 1 surfactant (available from Dow), and DOWFAX™ 25A414 (available from Dow).

Further suitable non-ionic surfactants can include water soluble ethoxylated C₆-C₁₈ fatty alcohols and C₆-C₁₈ mixed ethoxylated/propoxylated fatty alcohols. For example, the ethoxylated fatty alcohols can be C₁₀-C₁₈ ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates.

In one or more embodiments, a cleaning article of detergent composition may include, in addition to the above-described non-ionic surfactant(s), one or more anionic surfactants. Suitable anionic surfactants may include, for example, one or more salts (e.g., sodium, potassium, ammonium, and substituted ammonium salts such as mono-, di- and triethanolamine salts) of anionic sulfates, sulfonates, carboxylates, and sarcosinates. Example embodiments of anionic sulfates may include linear and/or branched primary and secondary alkyl sulfates, alkyl ethoxysulfates, fatty oleoyl glycerol sulfates, alkyl phenol ethylene oxide ether sulfates, C₅-C₁₇ acyl-N—(C₁-C₄ alkyl) and —N—(C₁-C₂ hydroxyalkyl) glucamine sulfates, and sulfates of alkylpolysaccharides, such as alkylpolyglucoside sulfates. Example embodiments of alkyl sulfates may include linear and branched primary C₁₀-C₁₈ alkyl sulfates. Example embodiments of alkyl ethoxysulfate surfactants may include C₁₀-C₁₈ alkyl sulfates that have been ethoxylated with from 0.5 to 20 moles of ethylene oxide per molecule. Example embodiments of anionic sulfonate surfactants may include C₅-C₂₀ linear alkylbenzene sulfonates, salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Example embodiments of anionic carboxylates may include alkyl ethoxy carboxylates, and alkyl polyethoxy polycarboxylates. In one or more embodiments, useful anionic surfactants may be selected from any one or more of sodium lauryl sulfate (SLS) and methyl ester sulfonate (MES). In one or more embodiments, ethoxylated anionic surfactants may be utilized and may comprise a limited number of moles of ethylene oxide groups, such as alkyl ether sulfate anionic surfactants that comprise less than 5 moles, or less than 4 moles of ethylene oxide groups, such as 1 to 4 or 2 to 3 ethylene oxide groups.

A total concentration of surfactants present in a cleaning article or a detergent composition of the present disclosure may vary and may be based on the total weight of the cleaning article (for example, including any film-former material that may be present in the article) or based on the total weight of the detergent composition (for example, excluding any film-former material that may be present in the article). In one or more embodiments, a cleaning article according to the present disclosure may comprise less than 50% by weight of surfactants, in total, based on the total weight of the cleaning article. In one or more embodiments, a cleaning article according to the present disclosure may comprise at least 10% by weight of surfactants, in total, based on the total weight of the cleaning article. For example, the cleaning article may comprise about 10% to about 49% by weight, about 20% to about 48% by weight, about 30% to about 47% by weight, or about 35% to about 45% by weight of surfactants, in total, based on the total weight of the cleaning article. In one or more embodiments, the cleaning article may comprise about 1% to about 15% by weight, about 2% to about 12% by weight, or about 3% to about 10% by weight of at least one non-ionic surfactant comprising a hydrocarbon chain length of C₁₅₊ₙ, where n is an integer from 1 to 10.

In one or more embodiments, cleaning articles may comprise a structural composition, which may include film former(s) and other components useful in forming the solid foam, and may also comprise a detergent composition, which may include one or more surfactants and any one or more additional detergent components or cleaning components otherwise discussed herein. The detergent composition may comprise about 5% to about 50% by weight, such as about 10% to about 48% by weight, such as about 15% to about 45% by weight, or such as about 20% to about 40% by weight of the cleaning article.

The detergent composition may comprise up to about 95% by weight of total surfactants, meaning at least one surfactant but optionally including a plurality of different surfactants, with “up to” in this instance meaning a lower range of any one of the following: at least 0.1% by weight, at least 0.5% by weight, or at least 1% by weight. For example, the detergent composition may comprise about 5% to about 95%, such as about 25% to about 92%, or about 50% to about 90% by weight of surfactants. The detergent composition may comprise up to about 50% by weight of non-ionic surfactants, such as up to about 35% by weight, such as up to about 25% by weight, or up to about 15% by weight of non-ionic surfactants based on the total weight of the detergent composition. For example, the detergent composition may comprise about 2% to about 45%, such as about 5% to about 35%, or about 8% to about 25% by weight of non-ionic surfactants based on the total weight of the detergent composition. Non-ionic surfactants comprising a hydrocarbon chain length of C₁₅₊ₙ, where n is an integer from 1 to 10, may comprise up to about 30% by weight, such as up about 25% by weight, or up to about 20% by weight of the detergent composition based on the total weight of the detergent composition. For example, non-ionic surfactants comprising a hydrocarbon chain length of C₁₅₊ₙ, where n is an integer from 1 to 10, may comprise about 2% to about 25% by weight, about 4% to about 20% by weight, or about 8% to about 16% by weight of the detergent composition based on the total weight of the detergent composition. In one or more embodiments, the detergent composition may comprise at least one non-ionic surfactant comprising a hydrocarbon chain length of C₁₅₊ₙ, where n is an integer from 1 to 10, and the detergent composition may comprise at least one non-ionic surfactant comprising a hydrocarbon chain length of 15 or less. In embodiments where the detergent composition comprises both of: A) at least one non-ionic surfactant comprising a hydrocarbon chain length of C₁₅₊ₙ, where n is an integer from 1 to 10; and B) at least one non-ionic surfactant comprising a hydrocarbon chain length of 15 or less, the ration of A to B (the “A/B ratio”) may be in a range of about 0.5 to about 10, such as about 0.8 to about 8, such as about 1 to about 6, such as about 1.5 to about 5, or such as about 1.5 to about 3.5.

Cleaning articles of the present disclosure can include a foam stabilizer configured to improve the physical and chemical stability of the solid foam structure. Foam stabilizers can include one or a plurality of materials that are effective to decrease interfacial tension of a gas/liquid and thereby reduce the tendency of coalescence and prevent collapse of the air pockets or bubbles in the foam. In some embodiments, the foam stabilizer can comprise one or more citrate esters. The citrate esters can include any form of citric acid that is esterified to include a plurality of alkyl chains of the same or different chain lengths. For example, the foam stabilizer can include triethyl citrate, triethyl o-acetyl citrate, tributyl citrate, or combinations thereof. In some embodiments, the foam stabilizer can be present in the disclosed cleaning articles in an amount ranging from about 0.1% to about 8%, about 0.5% to about 5%, or about 1% to about 3% by weight based on the total weight of the cleaning article.

The disclosed cleaning articles can also include an absorbent configured to improve the physical and chemical stability of the substantially solid foam structure. In some embodiments, the absorbent can comprise a clay-based material, a silica-based material, a starch, or combinations thereof. For example, the absorbent can include bentonite, silica powder, such as that available under the trade name SIPERNAT D 13, rice starch, or combinations thereof. In some embodiments, the absorbent can be present in the disclosed cleaning articles in an amount ranging from about 0.1% to about 10%, about 0.5% to about 8%, or about 1% to about 6% by weight based on the total weight of the cleaning article.

A cleaning article as disclosed herein can further include a film former. The film former may comprise, for example, a water soluble polymer. In one or more embodiments, the water soluble polymer can comprise a polyvinyl alcohol. In one or more embodiments, the water soluble polymer can comprise a cellulose-based polymer. In one or more embodiments, the cellulose-based polymer can be a polysaccharide. In one or more embodiments, the water soluble polymer can comprise any of hydroxypropyl methylcellulose (HPMC), methyl cellulose low-viscosity (MCLV), xanthan gum, pullulan, or any combination thereof. In one or more embodiments, any of the foregoing film-formers may be expressly excluded from the cleaning article disclosed herein. In one or more embodiments, the film former may be present in the disclosed cleaning articles in an amount of less than 50% by weight. In one or more embodiments, the film former may be present in the disclosed cleaning articles in an amount of at least 10% by weight. For example, the cleaning article may comprise about 10% to about 49% by weight, about 20% to about 48% by weight, about 30% to about 47% by weight, or about 35% to about 45% by weight of film formers, in total, based on the total weight of the cleaning article.

A film former useful for cleaning articles can be configured to bind surfactants present in the detergent composition such that in the formation of a solid foam structure described herein, the surfactants are substantially or completely retained by the solid foam structure. This may apply specifically to the non-ionic surfactants described herein and the ability to achieve a relatively high concentration loading of the non-ionic surfactant(s) in the cleaning article without weeping of the non-ionic surfactant(s) or other loss thereof from the solid foam structure. As mentioned above and detailed further below, in the formation of a solid foam structure, a film former described herein is mixed with a detergent composition described herein and processed to achieve a flowable foam. The flowable foam can then be dried to form a substantially solid foam structure. The substantially solid foam structure may retain substantially or completely all of the surfactant(s) present in the flowable foam before drying to form the substantially solid form. Substantially retained indicates that at least about 97% by weight of surfactant is retained by the cleaning article, such as about 97.5% or greater, such as about 98% or greater, or such as about 98.5% or greater, such as up to a maximum amount of about 99.99% by weight, all of the foregoing based on the amount of surfactant that was originally present in the flowable foam before drying to achieve that substantially solid foam. Completely retained also may indicate that about 99% or greater by weight of the surfactant is retained by the cleaning article, such as about 99% or greater, about 99.5% or greater, or about 99.5% or greater by weight being retained based on the amount of surfactant that was originally present in the flowable foam before drying to achieve that substantially solid foam. In one or more embodiments, the foregoing values for retained surfactant may reference non-ionic surfactants specifically or non-ionic surfactants with a carbon chain length of C₁₆ or greater specifically.

In one or more embodiments, a cleaning article as disclosed herein can include any one or more of the following components in any combinations thereof: water; polyvinyl alcohol; hydroxypropyl methyl cellulose; methyl cellulose high volume; methyl cellulose low volume; xanthan gum; pullulan; sodium C₁₄-C₁₆ olefin sulfonate; pentasodium DTPA; polyacrylate; polyether-polyester copolymer; C₁₂-C₁₄ alcohols ethoxylated; C₁₆-C₁₈ alcohols ethoxylated; sodium carbonate; sodium bicarbonate; dye; glycerin; fatty acid methyl ester ethoxylate; glyceryl cocoate; polyether functional silicone; soapberry extract (sapindus mukurossi); Lutensol® AT 25 ethoxylated alcohol; 1,2-benzisothiazolin-3-one; subtilisin; alpha-amylase; cellulase; mannanase; cornstarch; triethyl citrate; triethyl o-acetyl citrate; tributyl citrate; bentonite; silica powder; and rice starch.

A cleaning article according to the present disclosure can be prepared by combining a cleaning composition as discussed herein with a film former, such as a water soluble, cellulose-based polymer, as discussed above. The film former can be first dissolved in a suitable solvent, such as water. The cleaning composition can be fully or partially dissolved in the solvent with the film former or can be fully or partially dispersed in the solvent with the film former. The combination of the detergent composition and the film former can result in the formation of a flowable detergent/polymer mixture. The flowable detergent/polymer mixture can then be aerated to form a flowable foam. Aerating can be achieved using any suitable method. In some embodiments, sufficient aeration may be achieved through use of a high speed mixer. In some embodiments, it may be useful to flow gas into the detergent/polymer mixture to accelerate the dispersing of gas pockets through the mixture. Air or an otherwise inert gas may be used for such purpose. As non-limiting examples, arrangements such as a mixer with a whisk attachment, a counter rotating sweep, a screw agitator, or an integral air flow induction system can be used to incorporate sufficient aeration. Suitable branded mixers include Hobart mixers, Tri-Mix™ Turbo-Shear™ mixing systems from Lee Industries, high shear mixers available from Charles Ross & Son company, or Kitchen Aid mixers. The flowable foam can then be dried and cooled to form a substantially solid foam structure. Drying can include heating, such as up to a temperature of about 80° C., up to about 70° C., or up to about 60° C. for a time period. In various embodiments, the cleaning articles as disclosed herein can be prepared according to the preceding method. The cleaning articles according to the present disclosure and methods of preparation thereof include and are further defined by the examples set forth following.

### EXPERIMENTAL

In an example embodiment, a cleaning article was prepared in the form of a solid sheet with a foam structure. The composition for preparation of the cleaning article included: water; sodium C₁₄-C₁₆ olefin sulfonate; pentasodium diethylenetriaminepentaacetate (DTPA); sodium polyacrylate; dimethyl 1,4-benzenedicarboxylate polymer; alcohols C₁₂-C₁₄ ethoxylated; sodium bicarbonate; dye; polyvinyl alcohol; glycerin; fatty acids, coco, esters with polyethylene glycol mono-me ether; PEG-7 glyceryl cocoate; PEG-12 dimethicone; saponin; 1,2-benzisothiazoline-3-one; subtilisin; alpha-amylase; cellulase; and mannanase. The prepared article did not exhibit greasiness or other evident loss of liquid therefrom and provided good cleaning efficacy.

In another example embodiment, a cleaning article was prepared in the form of a solid sheet with a foam structure. The composition for preparation of the cleaning article included: water; sodium C₁₄-C₁₆ olefin sulfonate; pentasodium diethylenetriaminepentaacetate (DTPA); sodium polyacrylate; dimethyl 1,4-benzenedicarboxylate polymer; alcohols C₁₂-C₁₄ ethoxylated; sodium bicarbonate; dye; polyvinyl alcohol; glycerin; fragrance; PEG-12 dimethicone; saponin; alcohols C₁₆-C₁₈ ethoxylated; 1,2-benzisothiazoline-3-one; subtilisin; alpha-amylase; cellulase; and mannanase. The prepared article did not exhibit greasiness or other evident loss of liquid therefrom and provided good cleaning efficacy.

In an additional example embodiment, cleaning articles were prepared in the form of a solid sheet with a foam structure. The formulations for preparation of the cleaning articles included water; sodium C₁₄-C₁₆ olefin sulfonate; pentasodium diethylenetriaminepentaacetate (DTPA); sodium polyacrylate; dimethyl 1,4-benzenedicarboxylate polymer; alcohols C₁₂-C₁₄ ethoxylated; sodium bicarbonate; dye; polyvinyl alcohol; glycerin; fragrance; PEG-12 dimethicone; saponin; 1,2-benzisothiazoline-3-one; subtilisin; alpha-amylase; cellulase; mannanase, and different ethoxylated alcohols with varying degrees of ethoxylation. Specifically, Alfonic 1214GC-3 (Sasol Limited), a C₁₀-C₁₆ ethoxylated alcohol with a degree of ethoxylation of 3, was used in Composition 1. Alfonic 1214-9 (Sasol Limited), a C₁₀-C₁₆ ethoxylated alcohol with a degree of ethoxylation of 9, was used in Composition 2. Alkonat 250 flakes (Indorama Ventures), a C₁₆-C₁₈ ethoxylated alcohol with a degree of ethoxylation of 25, were used in Composition 3. Table 1 provides the formulations of Compositions 1-3. The percentages provided are weight percentages.

TABLE 1
Formulations of Compositions 1-3.

| Component | Comp. 1 | Comp. 2 | Comp. 3 |
|---|---|---|---|
| Water | 6.42% | 6.42% | 6.42% |
| Sodium C₁₄-C₁₆ olefin sulfonate | 31.00% | 31.00% | 31.00% |
| DPTA | 2.00% | 2.00% | 2.00% |
| Sodium polyacrylate | 2.00% | 2.00% | 2.00% |
| Dimethyl 1,4-benzenedicarboxylate | 2.00% | 2.00% | 2.00% |
| polymer | | | |
| Alcohols C₁₂-C₁₄ ethoxylated | 2.10% | 2.10% | 2.10% |
| Sodium Bicarbonate | 0.01% | 0.01% | 0.01% |
| Dye | 0.04% | 0.04% | 0.04% |
| Polyvinyl Alcohol | 40.32% | 40.32% | 40.32% |
| Glycerin | 2.00% | 2.00% | 2.00% |
| Fragrance | 5.00% | 5.00% | 5.00% |
| PEG-12 dimethicone | 0.50% | 0.50% | 0.50% |
| Saponin | 0.60% | 0.60% | 0.60% |
| 1,2-benzisothiazoline-3-one; | 0.01% | 0.01% | 0.01% |
| Subtilisin | 0.40% | 0.40% | 0.40% |
| Alpha-amylase | 0.01% | 0.01% | 0.01% |
| Cellulase | 0.20% | 0.20% | 0.20% |
| Mannanase | 0.01% | 0.01% | 0.01% |
| Alfonic 1214GC-3 | 5.20% | 0.00% | 0.00% |
| Alfonic 1214-9 | 0.00% | 5.20% | 0.00% |
| Alkonat 250 | 0.00% | 0.00% | 5.20% |

Efficacy tests for the cleaning article were completed for Composition 1 (Comp. 1), Composition 2 (Comp. 2), and Composition 3 (Comp. 3) using the method provided in ASTM D4265. Twenty-two (22) different stains were assessed on cotton and polycotton fabrics separately for a total of forty-four (44) stains. The average stain removal index (SRI) was determined for each composition for the stains. The smallest SRI, with a value of 1647, was for Composition 1. The largest SRI, with a value of 1711, was that for Composition 3. Composition 2 had a SRI value of 1677. Composition 3 had the greatest cleaning efficacy of the three compositions. Thus, the results indicated that longer chain alcohol ethoxylates with greater ethoxylation improve cleaning efficacy.

The terms “about”, “substantially”, and “generally” as used herein can indicate that certain recited values or conditions are intended to be read as encompassing the expressly recited value or condition and also values that are relatively close thereto or conditions that are recognized as being relatively close thereto. For example, unless otherwise indicated herein, a value of “about” a certain number or “substantially” or “generally” a certain value or result can indicate the specific number, value, or result as well as numbers, values, or results that vary therefrom (+ or −) 2% or less, or 1% or less. Similarly, unless otherwise indicated herein, a condition that substantially exists can indicate the condition is met exactly as described or claimed or is within typical manufacturing tolerances or would appear to meet the required condition upon casual observation even if not perfectly meeting the required condition. In some embodiments, the values or conditions may be defined as being express and, as such, the term “about” or “substantially” (and thus the noted variances) may be excluded from the express value. Where a plurality of possible lower end values and a plurality of possible upper end values are provided for a particular parameter, it is understood that all possible combinations of values inclusive of any of the lower end values and any of the upper end values are encompassed for describing the parameter.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A cleaning article comprising:
a detergent composition comprising at least one non-ionic surfactant with at least one associated hydrocarbon chain having a carbon chain length of greater than 15 carbon atoms; and
a film former comprising a water-soluble polymer;
wherein the cleaning article is configured as a substantially solid foam structure that is soluble in an aqueous liquid and is substantially non-flowing at a temperature of about 80° C. or less when out of contact with the aqueous liquid.

2. The cleaning article of claim 1, wherein the at least one non-ionic surfactant has at least one associated hydrocarbon chain having a carbon chain length of 16 to 20 carbon atoms.

3. The cleaning article of claim 1, wherein the at least one non-ionic surfactant has at least one associated hydrocarbon chain having a carbon chain length of 16 to 18 carbon atoms.

4. The cleaning article of claim 1, wherein the at least one non-ionic surfactant is an ethoxylated alcohol.

5. The cleaning article of claim 4, wherein the at least one non-ionic surfactant is a C₁₆-C₂₀ ethoxylated alcohol.

6. The cleaning article of claim 4, wherein the at least one non-ionic surfactant is a C₁₆-C₁₈ ethoxylated alcohol.

7. The cleaning article of claim 1, wherein the cleaning article comprises about 2% by weight or greater of the at least one non-ionic surfactant, based on the total weight of the cleaning article.

8. The cleaning article of claim 1, wherein the cleaning article comprises about 5% by weight or greater of the at least one non-ionic surfactant, based on the total weight of the cleaning article.

9. The cleaning article of claim 1, wherein the cleaning article comprises about 10% by weight or greater of the at least one non-ionic surfactant, based on the total weight of the cleaning article.

10. The cleaning article of claim 1, wherein the detergent composition further comprises one or more anionic surfactants.

11. The cleaning article of claim 1, wherein the water-soluble polymer is polyvinyl alcohol.

12. The cleaning article of claim 1, wherein the water-soluble polymer is a polysaccharide.

13. The cleaning article of claim 1, wherein the water-soluble polymer comprises hydroxypropyl methylcellulose (HPMC), methyl cellulose low-viscosity (MCLV), xanthan gum, pullulan, or combinations thereof.

14. The cleaning article of claim 1, wherein the detergent composition further comprises one or more materials selected from the group consisting of enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).

15. The cleaning article of claim 1, wherein the cleaning article is further configured as a sheet having a thickness, and a length and a width that are each greater than the thickness.
